(19) United States
(12) Patent Application Publication
(10) Pub. No.: US 2026/0062360 A1
(43) Pub. Date: Mar. 5, 2026

(54) SOIL ENHANCING COMPOSITIONS BASED ON CRUSTACEAN BY-PRODUCTS AND PROCESS FOR OBTAINING SAID COMPOSITIONS

(71) Applicants: Mónica Yasmín SERRANO GONZÁLEZ, Nuevo León (MX); Ilse Paulina ÁLVAREZ TREVIÑO, Nuevo León (MX); José T. OTERO PAPPATHEODOROU, Sonora (MX)

(72) Inventors: Mónica Yasmín SERRANO GONZÁLEZ, Nuevo León (MX); Ilse Paulina ÁLVAREZ TREVIÑO, Nuevo León (MX); José T. OTERO PAPPATHEODOROU, Sonora (MX)

(21) Appl. No.: 19/100,535

(22) PCT Filed: Aug. 1, 2023
(86) PCT No.: PCT/MX2023/050049

§ 371 Date: Jan. 31, 2025

Related U.S. Application Data
(60) Provisional application No. 63/394,141, filed on Aug. 1, 2022.

(51) Int. Cl. C05F 1/00; A01C 21/00; C05F 17/10; C05F 17/20; C05F 17/40; C05F 17/80

(52) U.S. Cl. CPC C05F 1/00; C05F 17/10; C05F 17/20; C05F 17/40; C05F 17/80; A01C 21/00

(57) ABSTRACT

A process is described for obtaining a soil-improving composition from the fermentation of crustacean exoskeletons for its use as a biostimulant, as well as the resulting composition of said process.

### CROSS REFERENCE TO RELATED APPLICATION

This application claims priority to the U.S. Provisional Patent Application No. 63/394,141 filed on Aug. 1, 2022, the contents of which are incorporated herein in their entirety by reference for all purposes.

### BACKGROUND OF THE INVENTION

The unproductive soils and the factors related to nutrient management, which encompass soil structure, nutrient supply, organic matter, and the scarcity of beneficial microorganisms, pose a significant challenge in achieving high crop yields. The imbalance between inorganic fertilizers and organic nutrients can hinder plant growth and limit agricultural productivity.

To address this issue, a comprehensive solution is required. Farmers need an effective composition that not only enhances crop yield but also revitalizes unproductive soils. This solution should promote the growth of beneficial microorganisms, improve the bioavailability of soil nutrients, enhance drainage, and increase water retention capacity.

Furthermore, reducing the dependency on excessive agrochemical products is essential for maintaining a sustainable and ecologically balanced ecosystem.

Biofertilizers and biostimulants can be used together to improve plant growth and health. While biofertilizers provide essential nutrients to plants, biostimulants help improve nutrient absorption and strengthen the plant's immune system.

The inventors of this application have developed a process for obtaining a chitin-based biostimulant that demonstrated potential to provide a comprehensive solution to the technical problem of improving yields across a variety of crops and the biological degradation of soil by increasing beneficial microorganisms in the soil and stimulating crops. Additionally, crustacean waste was used as the base material, which, if not utilized and biotechnologically modified through the process of the present invention, would have simply represented organic waste or, at best, compost material that does not offer a technical solution to unproductive soils.

Chitin is a linear polymer of N-acetyl-D-glucosamine (GlcNAc) linked by β-1,4 bonds, abundant in the shells of crabs, shrimp, and lobsters. Each year, between six and eight million tons of these chitinous wastes are produced worldwide, the majority of which are discharged into the sea or landfilled.

The functional properties and physiological activities of chitin oligomers mainly depend on the molecular weight and chain length. While most natural polysaccharides are neutral or acidic, chitin is basic. Chitin is the main component of the cuticles of most insects and of the peritrophic membranes that protect the intestines of insects.

Pathogenic bacteria that infect the intestines of crustaceans, for example, must first pass through this chitin-rich barrier. At the same time, chitin is present in the tracheal tubes of insects, on the surface of their skin, and in muscles, along with proteins and other components.

Chitin is hydrolyzed by two types of enzymes, namely chitinase (C.E. 3.2.1.14) and beta-N-acetylhexosaminidase (C.E. 3.2.1.52).

Many bacteria of the Bacillus genus, such as B. amyloliquefaciens, B. cereus, B. circulans, and B. thuringiensis, degrade chitin to meet their nutrient demands. For example, the chitin degradation system of B. circulans WL-12, a human pathogen, has been well studied and includes three chitinases (BcChiA1, BcChiC1, and BcChiD1). Chitinases from B. subtilis, a well-known microorganism for industrial protein production and biocontrol, have also been studied. Three chitinases with different molecular weights (20.6, 48, and 31 kDa) were purified from different B. subtilis strains. In another report, a chitinase gene from B. subtilis was cloned and expressed in Escherichia coli. However, the enzymatic activities of these chitinases against insoluble substrates like α-chitin and β-chitin have not been studied. A new chitinase from B. subtilis (BsChi) was expressed in E. coli and biochemically characterized. BsChi proved to be potent in degrading crab shells, outperforming the well-known SmChiA from Serratia marcescens and a commercial chitinase preparation from Streptomyces griseus. A two-component system, including BsChi and OfHex1 from the insect Ostrinia furnacalis, was subsequently introduced to produce GlcNAc from crab shells.

In recent years, some research has been conducted on the decomposition of seafood. For this purpose, new products have been obtained to recycle waste using chitinase enzyme with chemical or biological methods. In particular, pollution arising from the sea floor and oceans due to seafood death is prevented by the use of microorganisms (e.g., Vibrio furnis) possessing the chitinase enzyme, which breaks down chitin. Furthermore, the chitinase enzyme has a wide range of applications in the food industry, feed industry, cosmetics, medicine, and fertilizer production.

Document CN 103130914 published on Jun. 5, 2013, describes a method for preparing chitin and protein composite powder through microbial fermentation using shrimp waste. The product prepared in this document contains microbial mycoprotein and degradation products from plant and animal proteins, is rich in nutrition, and has functional activity. Its greatest advantage is the use of shrimp waste, which does not release any contaminants, and yields chitin and protein composite powder with high added value. This invention selects Lactobacillus bulgaricus and Bacillus subtilis for their strong acid and enzyme production capabilities to treat shrimp waste, removing proteins and calcium carbonate from shrimp shells to prepare chitin.

Additionally, document CN110093387 published on Aug. 6, 2019, provides a method for preparing chitosan oligosaccharides by synergistically degrading chitin present in shrimp and crab shells using microorganisms of the genus Bacillus and Paecilomyces and fermenting the shells to obtain water-soluble chitosan, chitosan oligosaccharides of different molecular weights, and glucosamine, effectively improving the conversion of chitin to chitosan oligosaccharides. The invention does not require a strong base or hydrochloric acid, does not pollute the environment, has mild production conditions, low energy consumption, and is in line with energy saving and emission reduction.

Document CN104357361 of Feb. 18, 2015, also describes that Bacillus subtilis is capable of producing chitinase and outlines media for its application. Bacillus subtilis (CGMCC No. 9166) is obtained through plasmid mutagenesis, resulting in higher chitinase and protease activity, and can be used as a leavening agent, probiotics, and preservative, with widespread applications in enzymatic preparations and the food industries.

In general, the known conditions in the state of the art for testing the chitinase activity of Bacillus subtilis strain Pla119 are as follows: a temperature of 35° C., a stirrer speed of 180 r/min, an inoculum size of 4%, an initial pH of 7.0, and a fermentation time of 48 hours. Reported products in the state of the art show that the chitinase activity of Bacillus subtilis Pla119 was 2.59±0.05 U/mL and protease activity was 146±0.07 U/mL.

### SUMMARY OF THE INVENTION

In one aspect of the present disclosure, a process is provided for obtaining a chitin-based soil improving composition; said process involves the fermentation of crustacean waste with bacteria of the Bacillus genus ssp.

In one embodiment of the invention, the process comprises the following steps:
mixing crustacean by-products with water;
adding an antifoaming agent;
adding a carbon source;
mixing the ingredients until a homogeneous mixture is obtained;
sterilizing the homogeneous mixture;
adding an inoculum of Bacillus genus ssp. bacteria, previously grown in Greenfort® culture medium;
incubating the mixture with continuous stirring and aeration for a determined time;
sterilizing the incubated mixture;
separating the solid phase and discarding the remainder;
drying the obtained solids.

### BRIEF DESCRIPTION OF THE FIGURES

FIG. 1 is a flowchart depicting the main stages of the process for obtaining a chitin-based soil improving biostimulant composition.

FIGS. 2A and 2B illustrate the activation of B. subtilis cells with Luria broth and with Greenfort® culture medium.

FIG. 3A illustrates the development of a strawberry plant without the chitin-based soil improving composition. FIG. 3B illustrates the development of a strawberry plant with the presence of the chitin-based soil improving composition.

FIG. 4A illustrates the development of a potato plant without the chitin-based soil improving composition. FIG. 4B illustrates the development of a potato plant with the presence of the chitin-based soil improving composition.

FIG. 5 shows the increase in cucumber Centauro yield using the chitin-based soil improving composition compared to a control using a technology package previously known to farmers.

FIG. 6A illustrates the development of a strawberry crop without the chitin-based soil improving composition. FIG. 6B illustrates the development of a strawberry plant crop with the presence of the chitin-based soil improving composition.

### DETAILED DESCRIPTION OF THE INVENTION

The present disclosure relates to soil improving compositions based on crustacean by-products and processes for obtaining the same. In some embodiments, the use of these soil improving compositions results in increased crop yield.

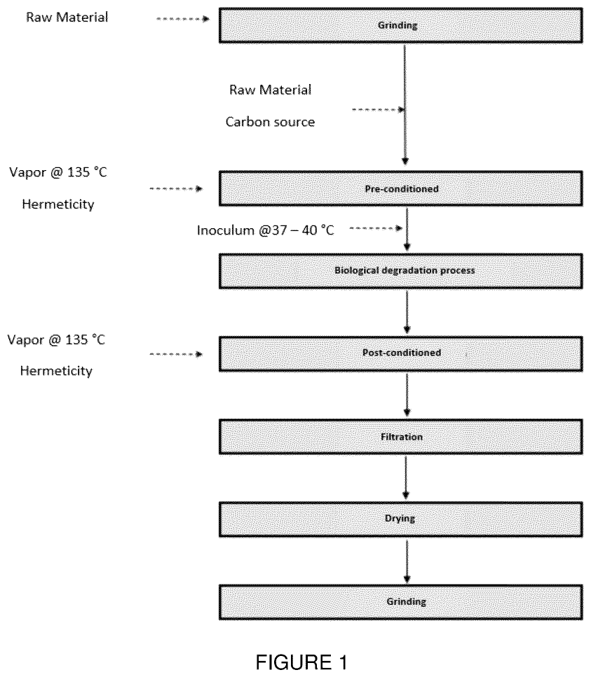

In a preferred embodiment of the invention, the process comprises the stages of FIG. 1. Specifically, the process follows the following steps:
mixing the crustacean by-products with water;
adding an antifoaming agent;
adding a carbon source;
mixing the ingredients for a sufficient time to obtain a homogeneous mixture;
sterilizing the homogeneous mixture to obtain a sterile mixture and to enhance, through pressure and temperature conditions, the bioavailability of the different active compounds; as well as to allow the removal of possible interfering microorganisms in the process;
cooling the sterile mixture and adding an inoculum of Bacillus genus ssp. bacteria, previously grown in Greenfort® culture medium;
incubating the mixture with continuous stirring and aeration for a determined time;
sterilizing the incubated mixture a second time to inactivate the bacteria used in the process;
separating the resulting liquid and solid phases, collecting the solids and discarding the remainder;
drying the obtained solids.

In a preferred embodiment of the invention, the crustacean by-products are waste from crustaceans, comprising crab, shrimp, lobster shells and/or a mixture thereof. More preferably, the waste is shrimp shells.

In another preferred embodiment of the invention, the antifoaming agents can be oils, polydimethylsiloxanes and/or silicones, certain alcohols, stearates, glycols and/or combinations thereof.

Preferred carbon sources in one embodiment of the present invention include sugarcane, sucrose, molasses, glucose, starch, lactose, fructose, corn syrup, and/or combinations thereof.

In a preferred embodiment of the process of the invention, fermentation is carried out in a bioreactor. Examples of bioreactors suitable for the process of the present invention include, but are not limited to, stirred tank bioreactors, fixed-bed bioreactors, bubble column bioreactors, fluidized-bed bioreactors, to name a few.

The Greenfort® culture medium is made from water, yeast(s), inorganic salts selected from the group consisting of sodium chloride, potassium chloride, nitrates, nitrites, calcium carbonate, magnesium carbonate; peptones and polysaccharides; and an additional ingredient selected from:
Plant proteins such as those derived from soy, pea; malt; etc.;
Free amino acids or forming protein complexes;
Linear or branched natural polymers;
Linear or branched chain starches; and
A fiber source from fruits, legumes, and cereals such as barley and oats; vegetables such as onion, carrot, turnip, broccoli, etc. said additional ingredients being present alone or in any combination with one or more of the other ingredients previously defined.

### Definitions

The term ‘sterilize’ or ‘sterilization’ refers to a set of temperature and pressure conditions that are maintained for a determined period of time. Specifically, for the present invention, sterilization is carried out at a temperature of 121° C. and a pressure of 103.421 kPa (15 psi) for at least 30 minutes. Another preferred sterilization embodiment is carried out at a temperature of 121° C. and a pressure of 103.421 kPa (15 psi) for at least 60 minutes.

The expression ‘bacteria of the Bacillus genus’ encompasses all bacteria that share the macroscopic and microscopic morphological characteristics typical of this genus, as described in detail in the state of the art. One skilled in the art will recognize those microorganisms that fit this description, including but not limited to Bacillus spp, Bacillus subtilis, Bacillus amyloliquefaciens, Bacillus cereus, Bacillus circulans, Bacillus thuringiensis, Bacillus anthracis, and Bacillus sphaericus, among others. Particularly preferred is the bacterium Bacillus subtilis.

The term ‘incubate’ or ‘incubation’ for the purposes of this document refers to a set of temperature and aeration conditions in a bioreactor; specifically, the temperature during the incubation stage is 37±1° C. with continuous stirring and an aeration rate of at least 125 L/min for a period of 110-120 hours.

The term ‘separate’ or ‘separation’ refers to a unit operation that includes separating the solid phase and liquid phase through filtration, decantation, ultrafiltration, or combinations thereof.

The term ‘dry’ or ‘drying’ for the purposes of this document refers to drying the solid phase at a temperature of 80±5° C. for a determined period of time or until a moisture content not exceeding 7% is reached.

The term ‘grind’ or ‘grinding’ refers to a unit operation that involves crushing a material to a particle size that passes through a No. 60 sieve.

In an optional embodiment of the invention, a grinding step is carried out after the final drying of the solids obtained from the fermentation process.

### EXAMPLES

### Example 1. Obtaining Soil-Improving Composition

### Sample Preparation

The raw material selected is waste from the shrimp industry. The shrimp shell must be previously dried, without meat, tail or head and ground to a minimum mesh size of 60. It must not contain stones, pieces of wood or other materials outside the shrimp exoskeleton.

### Activation of Microbial Cells

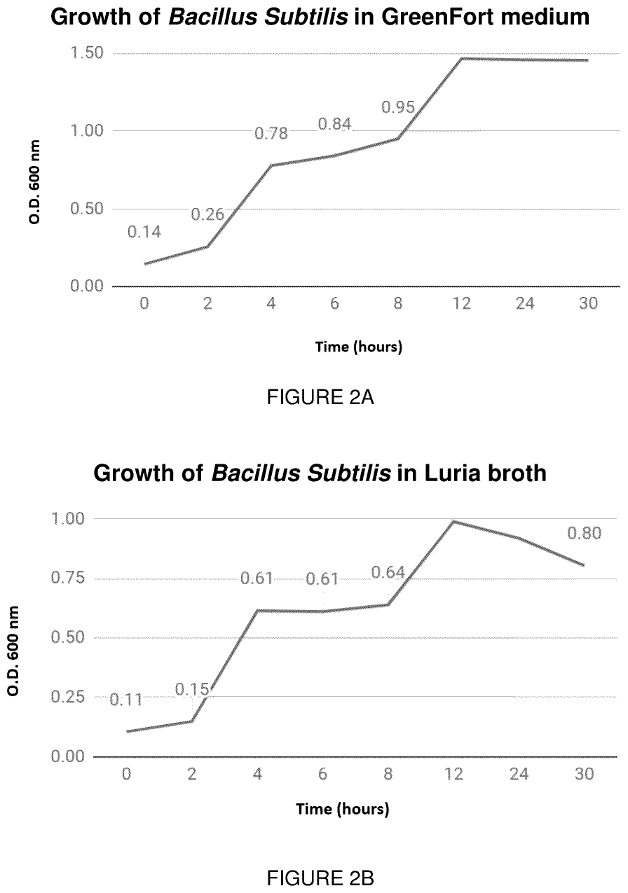

A strain of Bacillus subtilis isolated is used as an inoculum. The inoculum is activated by performing a 10% dilution in Luria Bertani (LB) broth at 2.5% (10 g/L of Tryptone, 10 g/L of NaCl, 5 g/L of Yeast Extract) plus 1% chitin source, and incubated at 37° C. for 1 day. The microbial cell growth is estimated by optical density measured at 600 nm. See FIGS. 2A and 2B. The activation is completed at an optical density of approximately 2. The microorganism concentration after activation is approximately 1.9 to 3.0% (w/v).

The bacteria are not cultured more than 5 times at specific time intervals to optimize enzyme production.

### Fermentation Control

100 kg of shrimp shells, already pulverized, are mixed with 400 kg of water, 10 kg of an antifoaming agent, and 25 kg of sugarcane inside a bioreactor. After all ingredients are thoroughly mixed, the entire mixture is brought to 121° C., 103.421 kPa (15 psi) for a minimum of 1 hour for sterilization. The bioreactor is allowed to cool, and then 40 kg of the inoculum (0.8 kg of bacteria) are activated to an optical density (OD) of 2.0. The mixture is incubated at 37° C. with continuous stirring and aeration at a minimum of 125 L/min for 120 hours.

### Bacterial Inactivation

After 120 hours of fermentation, the entire mixture is brought to 121° C., 103.421 kPa (15 psi) for a minimum of 30 minutes for sterilization in order to inactivate the bacteria used in the process, ensuring that the final product does not contain active microorganisms that could affect shelf life, while also facilitating compliance with health regulations in a simpler and more efficient manner.

### Conditions of Separation

The fermentation product consists of a liquid and solid phase. The liquid hydrolysates are separated by filtration, and the solids are collected. The solid phase materials are dried at 80° C., maintaining no more than 7% moisture, thus forming a soil-improving composition that contains chitin. All other fractions are discarded from the process.

### Example 2. Use of the Improving Composition in Agricultural Crop Soils

The composition obtained in Example 1 has great stability in interaction with the environment as it is composed of macromolecules. Therefore, it maintains flexible compatibility with different compounds, PH levels, and temperatures used when applying it to agricultural crop soils. The particle size of the final product, i.e., approximately 70±5 microns, is also relevant as the final product is insoluble in water and, therefore, must remain in suspension to be used in any type of fertigation equipment.

Six kilograms per hectare are applied in addition to the normal technological package used by each farmer, with no prior activation or preparation of the soil or product required for application.

Positive effects were observed in different types of productive crops, mainly in vegetables and berries. The main improvements observed include increased yield, improved quality, nematicidal activity, increased soil moisture retention, improved flower count, improved fruit ripening time, increased fruit shelf life, increased beneficial microorganisms, and reduced pathogenic microorganisms in the soil.

A synergy has also been observed where the composition of the invention enhances the benefits of biological products already used by farmers and the biological agents already present in the crop soil, having a positive impact on the regeneration of agricultural soils.

### 2.1 Strawberry I

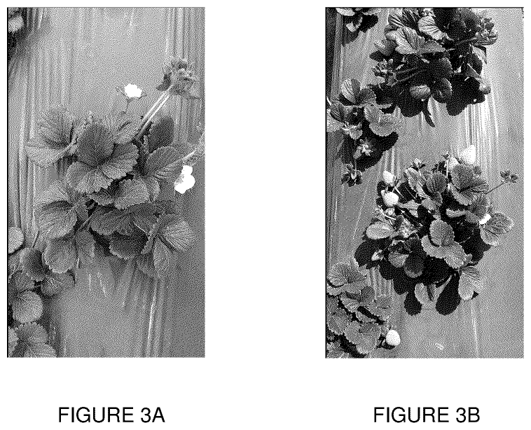

6 kg/hectare of the soil-improving composition were used in strawberry fields, resulting in a 32% increase in yield, as shown in FIGS. 3A and 3B.

### 2.2 Potato

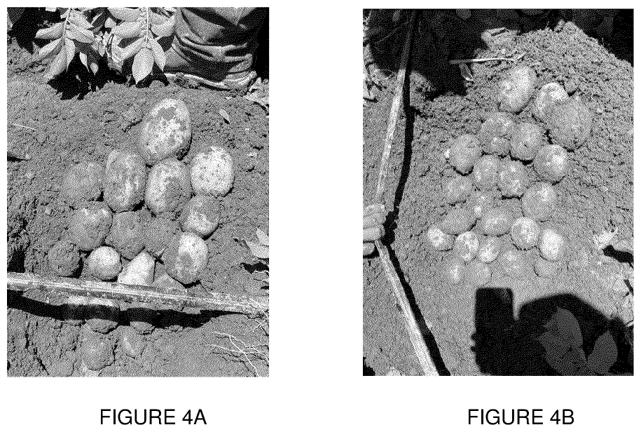

8 kg/hectare of the soil-improving composition were used in potato fields located in Nuevo León, Mexico, resulting in a 12% increase in yield. FIGS. 4A and 4B illustrate the results obtained.

### 2.3 Tomato

In the northeast of Mexico, in a saladette tomato crop, benefits were observed in restoring harvested yield in low-productivity areas within a shaded mesh greenhouse with the application of the soil-improving composition. A 162% increase in harvested weight was observed in the area with deteriorated soil, nearly homogenizing production compared to the control, as shown in the following table.

TABLE 1
Comparison between the performance obtained with and
without application of the improving composition.

| | |
|---|---|
| Harvest Zone 1 | Harvest Zone 2 |
| [Damaged soil] | [Control] |

| | |
|---|---|
| Expected crop yield | 12 kg/m² |

| | | |
|---|---|---|
| Previous crop cycle | 5.84 kg/m² | 12.06 kg/m² |
| [Without application of | | |
| improving composition] | | |
| Actual harvest cycle | 15.33 kg/m² | 19.50 kg/m² |
| [With application of | | |
| Greenfort ® soil-improving | | |
| composition] | | |

### 2.4 Cucumber

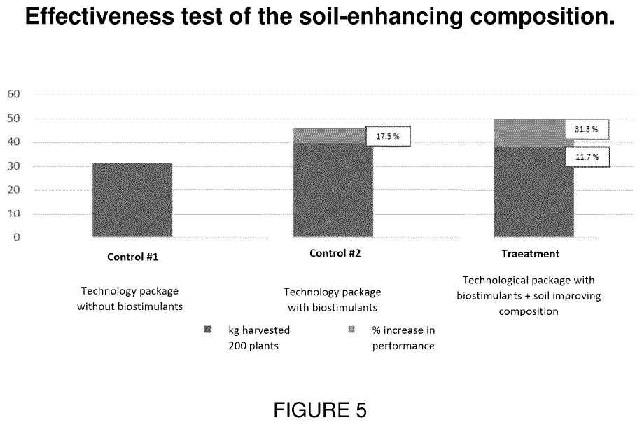

FIG. 5 illustrates the results obtained from applying the soil-improving composition in fields in central Mexico, where a statistically significant 12% increase in the harvested yield of Centauro cucumber was observed compared to the control that uses a technological package previously known by the producers.

### 2.5 Strawberry II

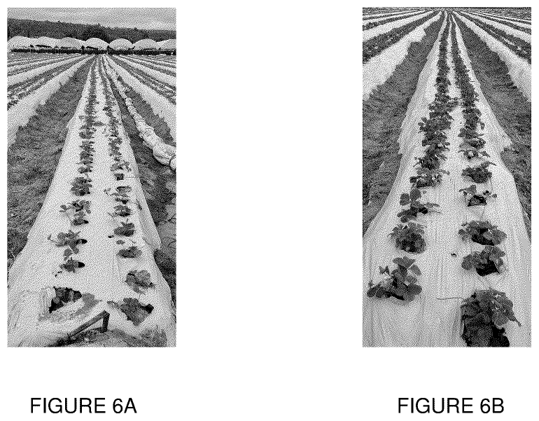

6 kg/hectare of the soil-improving composition were used in strawberry fields, resulting in a 24% increase in yield. FIGS. 6A and 6B illustrate that the number of flowers, the number of fruits, the shelf life of the fruits, and the number of beneficial soil bacteria and fungi also increased.

### 2.6 Blackberry

The soil-improving composition was used in the west of Mexico, with a dose of 6 kg per hectare for blackberry cultivation in open fields. Random soil samples were taken at the beginning of planting and at harvest time, from the treated area and the control area, and sent for microbiological analysis by third-party laboratories. Table 2 shows an improvement in the number of CFU/gram of beneficial soil microorganisms, such as nitrogen fixers, phosphorus solubilizers, bacilli, Trichoderma, among others. Furthermore, in the treated area, a 35% improvement was observed in the reduction of Fusarium, the only phytopathogen initially present in the soil.

TABLE 2
Benefits observed from the use of
the improving composition in Blackberry.
Comparative treatment between the treated
surface and the control surface

| | Phyto-beneficial | |
|---|---|---|
| | microorganisms | Phytopathogens |
| Percentage of | Improvements observed | Improvements observed |
| improvement | from the treatment with | with the treatment using |
| | the soil-improving | the soil-improving |
| | composition vs control. | composition vs control. |
| | Aerobic bacteria: | The levels of soil pathogens |
| | Increase in the number | remained stable throughout |
| | of CFU/g by 64%. | the cycle. |
| | [1.6 times higher | Results based on the |
| | concentration]. | start of the cycle (before |
| | The concentration in the | treatment): |
| | soil remained at a LOW | Regarding the amount of |
| | level. | Fusarium fungus in the soil |
| | Anaerobic bacteria: | at the start of the cycle and |
| | Increase in the number | before the treatment, the |
| | of CFU/g by 25%. | following was observed: |
| | [1.25 times higher | The treated area with the |
| | concentration]. | improving composition |
| | In both areas, the | showed a 35% decrease in |
| | concentration increased | the pathogen amount. The |
| | to HIGH. | disease was reduced by |
| | Nitrogen-fixing bacteria: | 2.85 times. The control |
| | Increase in the number | area, at the end of the |
| | of CFU/g by 20%. | cycle, showed a 25% |
| | [1.2 times higher | increase in Fusarium |
| | concentration]. | concentration. The disease |
| | The concentration | incidence increased by 1.25 |
| | increased to HIGH. | times. |
| | Phosphorus-solubilizing | Results based on the end |
| | bacteria: | of the cycle as the |
| | Increase in the number | reference area: |
| | of CFU/g by 36%. | The treated area reduced |
| | [1.36 times higher | Fusarium in the soil by 48% |
| | concentration]. | compared to the control |
| | The concentration | sampled at the end of the |
| | remained at LOW. | crop cycle. The disease |
| | Bacillus sp.: | was reduced by 2.08 times.” |
| | Increase in the number | |
| | of CFU/g by 50%. | |
| | [1.5 times higher | |
| | concentration]. | |
| | The concentration | |
| | increased to HIGH. | |
| | Trichoderma sp.: | |
| | Increase in the number | |
| | of CFU/g by 500%. | |
| | [6 times higher | |
| | concentration]. | |
| | The concentration | |
| | remained LOW. | |
| | Aspergillus sp.: | |
| | Increase in the number | |
| | of CFU/g by 500%. | |
| | [6 times higher | |
| | concentration]. | |
| | The concentration | |
| | remained LOW. | |
| | Actinomycetes: | |
| | Increase in the number | |
| | of CFU/g by 71%. | |
| | [1.7 times higher | |
| | concentration]. | |
| | The concentration | |
| | remained LOW. | |

Although the invention has been described and exemplified in sufficient detail to be made and used by those experts in the technique, several alternatives, modifications, and improvements will be apparent without departing from the scope of the invention. The examples provided in this specification are representative of the preferred embodiments, are illustrative, and are not intended to be limiting the scope of the invention. Those experts in the technique will conceive modifications to it and other uses. These modifications are encompassed within the scope of the invention as defined in the claims.

1. A method for obtaining a soil-enhancing composition, the method characterized in that it comprises:
mixing crustacean by-products with water;
adding an anti-foaming agent;
adding a carbon source;
mixing the ingredients for a time sufficient to obtain a homogeneous mixture;
sterilizing the homogeneous mixture to obtain a sterile mixture;
allowing the sterile mixture to cool and adding an inoculum of Bacillus genus bacteria;
incubating the mixture with continuous stirring and aeration for a determined time;
sterilizing the incubated mixture a second time to inactivate the bacteria used in the process;
separating the resulting liquid and solid phases, collecting the solids and discarding the rest;
drying the obtained solids.

2. The method according to claim 1, further characterized in that the crustacean by-products comprise shrimp shells.

3. The method according to claim 1, further characterized in that the Bacillus genus bacteria consists of Bacillus subtilis.

4. The method according to claim 1, further characterized in that the carbon sources are selected from the group consisting of sugar cane, sucrose, molasses, glucose, starch, lactose, fructose, corn syrup, and/or combinations thereof.

5. The method according to claim 1, further characterized in that the antifoaming agents are selected from the group consisting of oils, polydimethylsiloxanes and/or silicones, certain alcohols, stearates, glycols, and/or combinations thereof.

6. The method according to claim 1, further characterized in that the incubation step is carried out at 37±1° C. with continuous agitation and aeration of at least 125 L/min for a period of 110-120 hours.

7. The method according to claim 1, further characterized in that the drying step comprises drying at 80±5° C. until a moisture content of no more than 7% is achieved.

8. A soil-improving composition obtained by the process of claim 1.

9. The use of a soil-improving composition according to claim 8, to increase the number of beneficial microorganisms in the soil.

10. The use of a soil-improving composition according to claim 8, to increase crop yield.
